(19) United States
(12) Patent Application Publication
(10) Pub. No.: US 2026/0165429 A1
(43) Pub. Date: Jun. 18, 2026

(54) Bail for Securing Pendants

(71) Applicant: Sehti Na, Los Angeles, CA (US)

(72) Inventor: Sehti Na, Los Angeles, CA (US)

(21) Appl. No.: 18/985,651

(22) Filed: Dec. 18, 2024

Related U.S. Application Data
(60) Provisional application No. 63/611,424, filed on Dec. 18, 2023.

(51) Int. Cl. A44C 3/00

(52) U.S. Cl. CPC A44C 3/008

(57) ABSTRACT

A bail including a body having a first surface and a second surface. The first surface and the second surface are spaced by a continuous sidewall. The body has a first end and a second end opposite the first end. The bail includes a primary opening that extends through the body from the first surface to the second surface. The bail includes a secondary opening extending from the primary opening towards the sidewall to a secondary opening end. The secondary opening forms a secondary opening surface that is disposed between the first surface and the second surface. The bail also includes a tertiary opening disposed between the primary opening and the secondary opening.

### RELATED APPLICATIONS

This utility patent application claims priority from and the benefit of the filing date of Provisional Patent Application Ser. No. 63/611,424 filed Dec. 18, 2023 in accordance with 35 U.S.C. §§ 119(e) and 120, the disclosure of which is expressly incorporated herein by reference.

### BACKGROUND

Necklaces having charms and pendants have been a longstanding and cherished form of personal adornment. The attachment of these decorative elements to a necklace chain may be facilitated by a component known as a “bail” or “bale”. A bail serves as a connector between the pendant or charm and the necklace chain, allowing for a secure and aesthetically pleasing arrangement.

Bails may have a range of designs and functionalities. These often involve mechanisms to hold the pendant in place on the chain, providing stability and preventing unwanted movement. However, existing solutions have faced certain challenges.

One common issue pertains to the ease of pendant attachment and adjustment on the chain. Some bails may lack user-friendly features, making it cumbersome for individuals to affix and reposition their charms or pendants to achieve a desired look. The intricacies of these bails can also lead to difficulties in maintaining a consistent and visually appealing arrangement.

In some cases, bails resembling simple metal loops allow the pendant to slide or rotate along the chain, disrupting the intended positioning and potentially diminishing the overall aesthetic appeal. A recurring issue in necklace design involves the migration of locks and clasps towards the front of the chain, near the center focus where pendants are typically positioned. This migration not only disrupts the symmetry and balance of the necklace but also poses challenges in maintaining the intended focal point. The need for a bail that addresses these challenges and provides an elegant, user-friendly solution is evident.

Additionally, as fashion trends evolve, there is a growing demand for versatility in pendant placement. Some bails may not offer the flexibility to secure the pendant in different directions on the chain or onto chains of different chain types, limiting the wearer's ability to customize their necklace according to personal preferences.

### BRIEF SUMMARY

According to one aspect, a bail includes a body having a first surface and a second surface. The first surface and the second surface are spaced by a continuous sidewall. The body has a first end and a second end opposite the first end. The bail includes a primary opening that extends through the body from the first surface to the second surface. The bail includes a secondary opening extending from the primary opening towards the sidewall to a secondary opening end. The secondary opening forms a secondary opening surface that is disposed between the first surface and the second surface. Further, the bail includes a tertiary opening disposed between the primary opening and the secondary opening.

According to another aspect, the bail includes a body having a first surface and a second surface. The first surface and the second surface are spaced by a continuous sidewall. The body has a first end and a second end opposite the first end. The bail includes a primary opening through the body from the first surface to the second surface. The bail also includes a secondary opening extending from the primary opening towards the sidewall to a secondary opening end. The secondary opening forms a secondary opening surface disposed between the first surface and the second surface. The bail includes a tertiary opening disposed between the primary opening and the narrow opening end. Further, the bail includes a first recessed area located at the secondary opening end and a second recessed area located between the tertiary opening and the primary opening. The first and second recessed areas can be located on either the first surface or second surface, or both surfaces. The first and second recessed areas can form a variety of shapes and can be concave.

In yet another aspect, the bail includes a body having a first surface and a second surface. The first surface and the second surface are spaced by a continuous sidewall. The body has a first end and a second end opposite the first end. The bail includes a primary opening through the body from the first surface to the second surface, and a secondary opening extending from the primary opening towards the sidewall to a secondary opening end. The secondary opening forms a secondary opening surface disposed between the first surface and the second surface. The bail further includes a tertiary opening disposed between the primary opening and the secondary opening end. A first recessed area is located at the secondary opening end where a fifth recessed area is disposed within the first recessed area. The bail also includes a second recessed area between the tertiary opening and the primary opening. The secondary opening end can have an additional recessed portion disposed within the first recessed area. The recessed portion can form a variety of shapes and can be concave. Further, the secondary opening surface of the secondary opening can be curved in either a concave or convex manner or can have a plurality of planar sections disposed within the secondary opening surface.

### BRIEF DESCRIPTION OF THE DRAWINGS

The accompanying drawings, which are incorporated in and constitute a part of the specification, illustrate various embodiments of the disclosure. Elements may not be drawn to scale. It is appreciated that similar reference numerals reference similar elements across multiple figures. However, it is also appreciated that different reference numbers do not imply dissimilar elements. Those having skill in the art will recognize the features unifying the embodiments herein described and, further, that the scope of the features claimed herein are not limited to the exemplary embodiments illustrated in the Figures.

FIG. 1A is a front view of a bail according to an exemplary embodiment;

FIG. 1B is a rear view of the bail of FIG. 1A according to an exemplary embodiment;

FIG. 1C is a right perspective view of the bail of FIG. 1A according to an exemplary embodiment;

FIG. 1D is a left side perspective view of the bail of FIG. 1A according to an exemplary embodiment;

FIG. 1E is a left side view of the bail of FIG. 1A according to an exemplary embodiment;

FIG. 2A is perspective view of the bail of FIG. 1A coupled with a link chain according to an exemplary embodiment;

FIG. 2B is a rear view of the bail shown in FIG. 2A coupled with the link chain according to an exemplary embodiment;

FIG. 3A is a front view of a bail according to another exemplary embodiment;

FIG. 3B is a rear view of the bail of FIG. 3A according to an exemplary embodiment;

FIG. 3C is a right perspective of the bail of FIG. 3A according to an exemplary embodiment;

FIG. 3D is a left side perspective view of the bail of FIG. 3A according to an exemplary embodiment;

FIG. 3E is a left side view of the bail of FIG. 3A according to an exemplary embodiment;

FIG. 4A is a perspective view of the bail from FIG. 3A coupled with a ball chain according to an exemplary embodiment; and

FIG. 4B is a rear view of the bail shown in FIG. 4A coupled with the ball chain according to an exemplary embodiment.

### DETAILED DESCRIPTION

The bail disclosed herein allows for secure and customized attachment of ornamental components (e.g., a pendant, a charm, other decorative elements) to articles of jewelry (e.g., a chain, a necklace, a bracelet). More specifically, when coupled to a chain, the bail remains in a set position and does not slide up or down the chain, thereby preventing the rotation and migration of ornamental components. Accordingly, the bail allows for secure attachment of one or more ornamental components on a particular portion of a chain and prevents the ornamental components from rotating or sliding to unwanted areas of the chain. The bail can be coupled with a variety of chain types, with the links of the chain including rings, balls, and a combination of loops and balls.

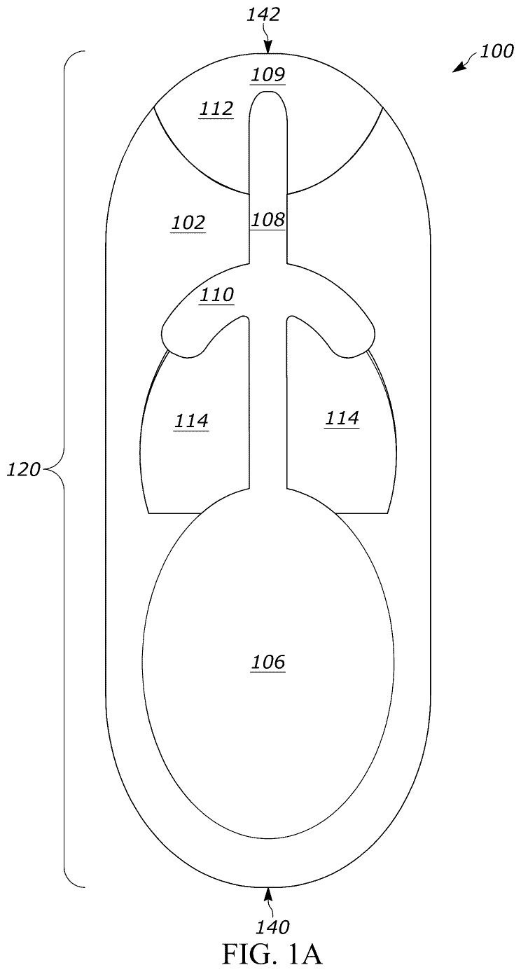

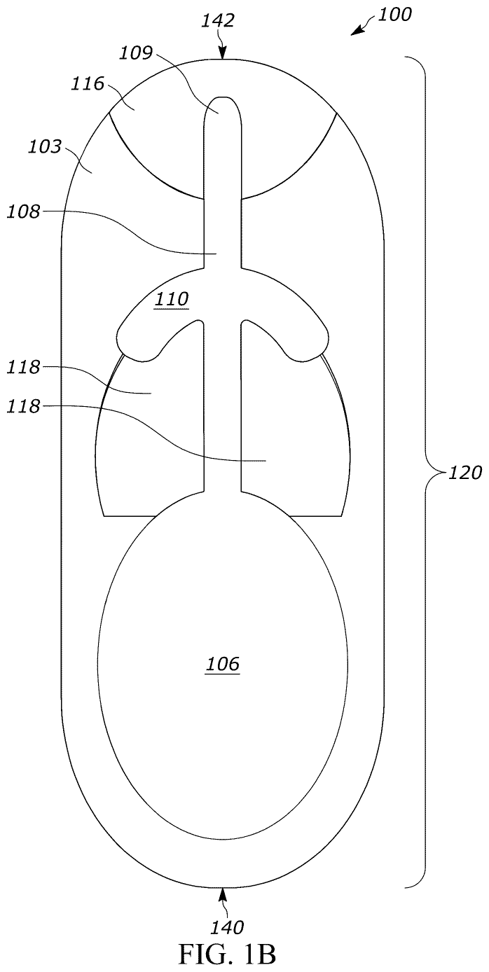

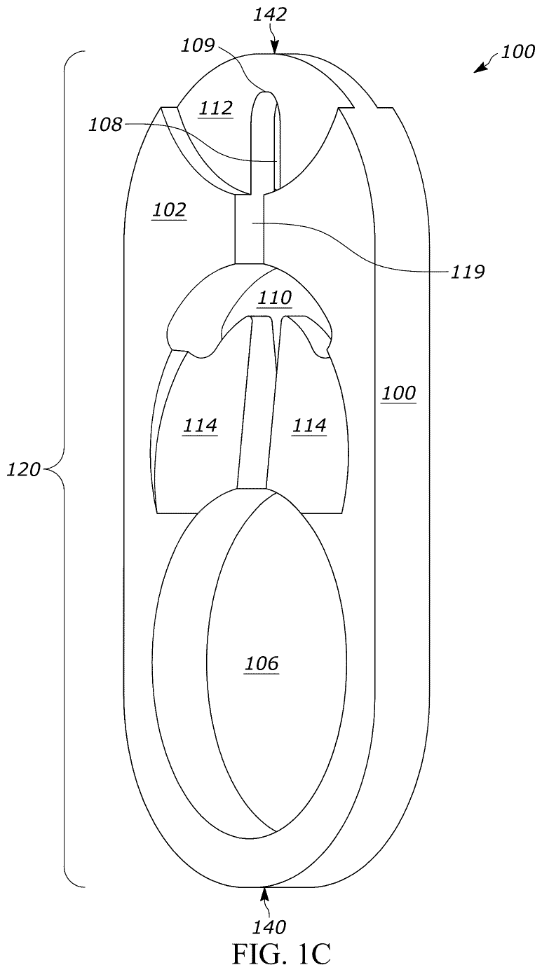

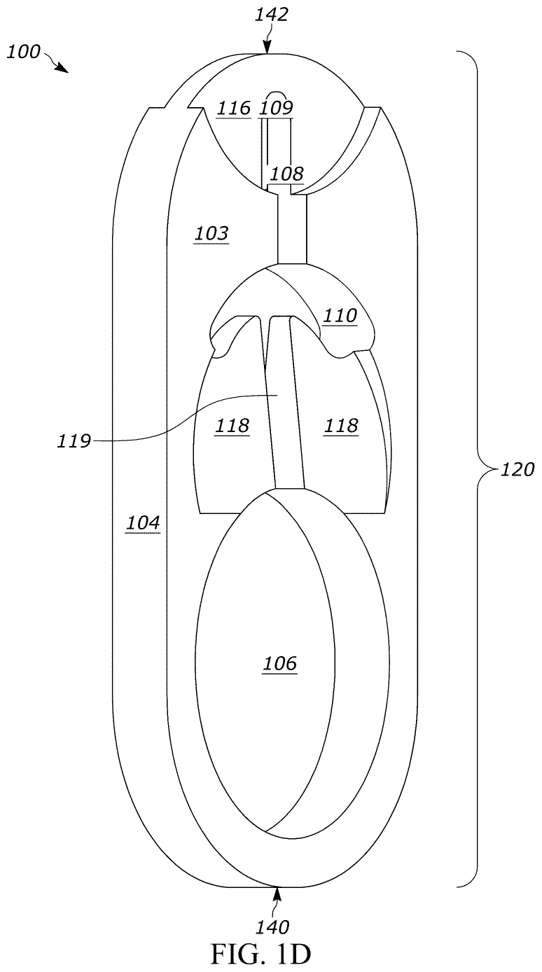

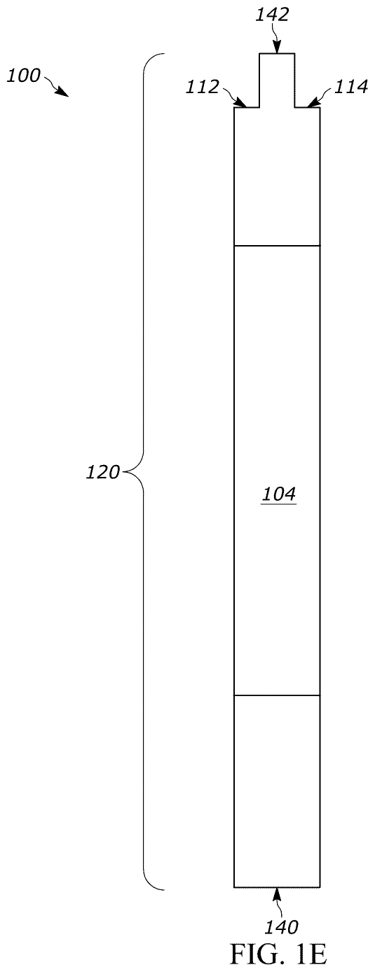

Referring now to the drawings, wherein the showings are for purposes of illustrating one or more exemplary embodiments and not for purposes of limiting the same, a bail is generally indicated at reference numerals 100 and 300 in the various Figures, wherein numbered elements in the figures correspond to like numbered elements herein. More specifically, FIGS. 1A-1E illustrate an exemplary embodiment of a bail 100. The bail 100 is defined by a body 120 having a first end 140 and a second end 142. The body 120 is further defined by a first surface 102 and a second surface 103 that are spaced by a continuous sidewall 104. The second surface 103 can be a mirror image of the first surface 102, including the openings and recessed areas discussed below. The bail 100 can be made of any rigid or flexible material known in the art. For example, the bail 100 can be made of metal including gold, silver, aluminum, steel, brass, copper, nickel, and other metals known in the art. Alternatively, the bail 100 can be made of polymer materials including plastics and rubbers.

A primary opening 106 is disposed at the first end 140 of the body 120. The primary opening 106 extends through the body 120 from the first surface 102 to the second surface 103. A secondary opening 108 extends from the primary opening 106 towards the continuous sidewall 104 in the direction of the second end 142 of the body 120, terminating at a secondary opening end 109, which does not interrupt the continuous sidewall 104. The secondary opening 108 extends through the body 120 from the first surface 102 to the second surface 103.

A secondary opening surface 119 extends between the first surface 102 and the second surface 104 along the boundary of the secondary opening 108. The secondary opening surface 119 can be curved, planer, a combination of connected planar segments, or combination of planar and curved segments. For example, in FIGS. 1A-1E, the secondary opening surface 119 is a combination of curved and planar segments.

Between the primary opening 106 and the secondary opening end 109, a tertiary opening 110 extends from the secondary opening 108. In some embodiments, the tertiary opening 110 extends transversely from the secondary opening end 109. The tertiary opening 110 extends through the body 120 of the bail 100 from the first surface 102 to the second surface 103. The tertiary opening 110 can be many shapes, including but not limited to arcuate, concave, and polyhedral shapes. For example, in FIGS. 1A-1E, the tertiary opening 110 is concave.

The bail 100 also includes a first recessed area 112 disposed around the secondary opening end 109. The first recessed area 112 may be parallel with the first surface 102, angled relative to the first surface 102, or concave. For example, in FIGS. 1A-1E, the first recessed area is recessed into the first surface 102 of the bail 100 around the secondary opening end 109 at the second end 142 of the bail 100. The first recessed area 112 can extend from the secondary opening end 109 to the continuous sidewall 104, and may be many shapes, including but not limited to arcuate, concave, and polyhedral shapes.

A second recessed area 114 is disposed on the body 120 between the primary opening 106 and the tertiary opening 110. The second recessed area 114 is recessed into the first surface 102 of the bail 100 in an area between the primary opening 106 and the tertiary opening 110. The secondary opening 108 can bisect the second recessed area 114. The second recessed area 114 may be angled or form a concave shape such that a depth of the second recessed area 114 is greater at the end or ends disposed toward the tertiary opening 110 than the end or ends disposed toward the primary opening 106. The second recessed area 114 may be many shapes, including but not limited to arcuate, concave, and polyhedral shapes. For example, in FIGS. 1A-1E, the second recessed area 114 is concave.

A third recessed area 116 may be present opposite the first recessed area 112 on the second surface 103. The third recessed area 116 may mirror the first recessed area 112 or may vary in shape, angle, and depth from the first recessed area 112. A fourth recessed area 118 may be present opposite the second recessed area 114 on the second surface 103. The fourth recessed area 118 may mirror the second recessed area 114 or may vary in shape, angle, and depth.

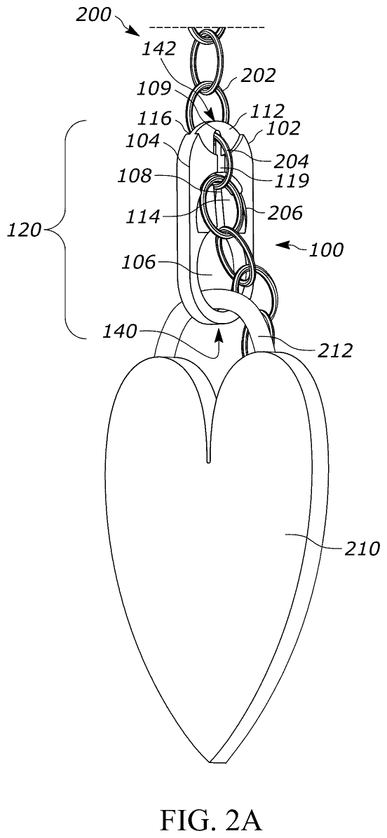

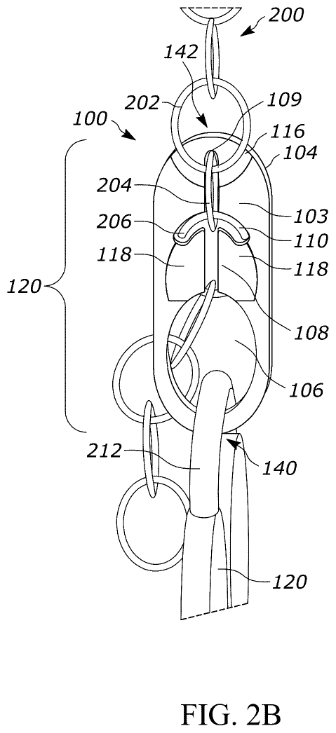

As will now be discussed in more detail, the recessed areas allow for receiving and coupling with elements of a chain, thereby securing the bail to the chain. As an illustrative example, FIGS. 2A and 2B show the bail 100 having an attached charm 210 where the bail 100 engages with a chain 200 according to an exemplary embodiment. In this example, the charm 210 includes a charm ring 212 and the charm 210 can be attached to the bail 100 by passing the charm ring 212 through the primary opening 106. The chain 200 includes a plurality of elements connected to each other thereby creating a string of elements (e.g., a chain, a necklace, a bracelet). For example, the plurality of elements includes at least a first element 202 connected to a second element 204. The string of elements created by the plurality of elements can form an annular shape. For example, although not shown, a first clasp portion and a second clasp portion can be provided respectively at the ends of the chain, and when the first portion and the second portion are engaged to form a clasp, the chain is then formed into a round shape. It is understood that in the embodiments discussed herein, the plurality of elements may be referred to as links or balls. In some embodiments, each of the plurality of elements are interlocked to form the chain. In other embodiments, each of the plurality of elements are linked together by threading a wire through each element.

In FIGS. 2A and 2B, the chain 200 includes a plurality of links (e.g., a plurality of elements) that interconnect, namely, a first link 202, a second link 204, and a third link 206. For simplicity, three links are numbered in the drawings, however it is understood that the chain 200 includes additional links. The connecting links can be round, oval, polygonal, or any other shape with smooth rounded corners. In this illustrative example, the chain 200 is a necklace, however, it is understood that the bail 100 can be implemented with other articles of jewelry having a plurality of elements, for example, a bracelet. As discussed herein, this allows for securing a charm 210 at a specific position on the chain 200 and prevents the charm 210 from repositioning (e.g., moving, sliding) to another portion of the chain 200.

Referring again to FIG. 2A and FIG. 2B, the primary opening 106 allows for the chain 200 to pass through the primary opening 106. The first link 202 couples with the third recessed area 116 on the second surface 103. A second link 204, interconnected with the first link 202, is passed through the secondary opening 108 and sits (e.g., engages) at the secondary opening end 109. As shown in FIG. 2A, a third link 206, interconnected with the second link 204, couples with the second recessed area 114 on the first surface 102. The third link 206 partially enters the tertiary opening 110 as shown in FIG. 2B.

The combination of the first link 202 coupled with the third recessed area 116, the second link 204 coupled with the secondary opening end 109, and the third link 206 coupled with the second recessed area 114 and the edge of the tertiary opening 110 secures the bail 100 to the chain 200, preventing the bail 100 from moving down the chain 200. Thus, the charm 200 is restricted from moving or sliding along the chain 200.

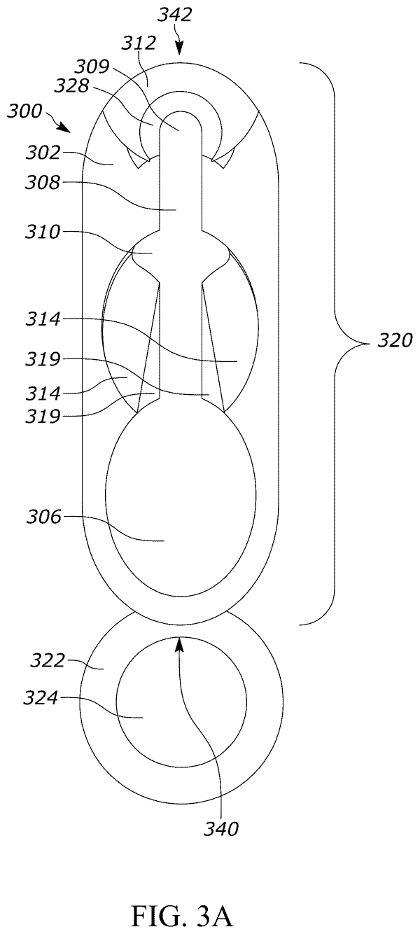

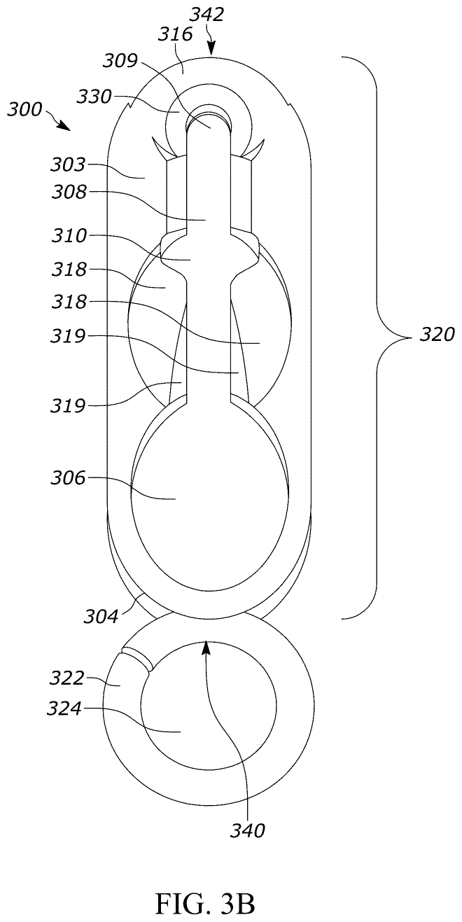

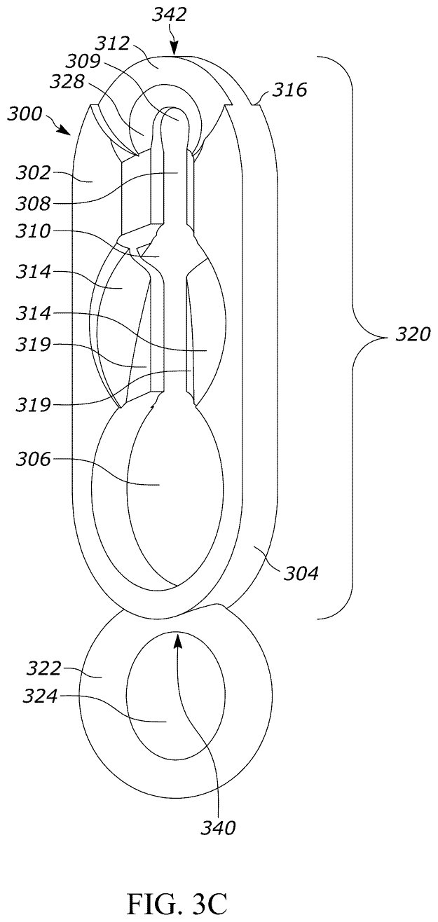

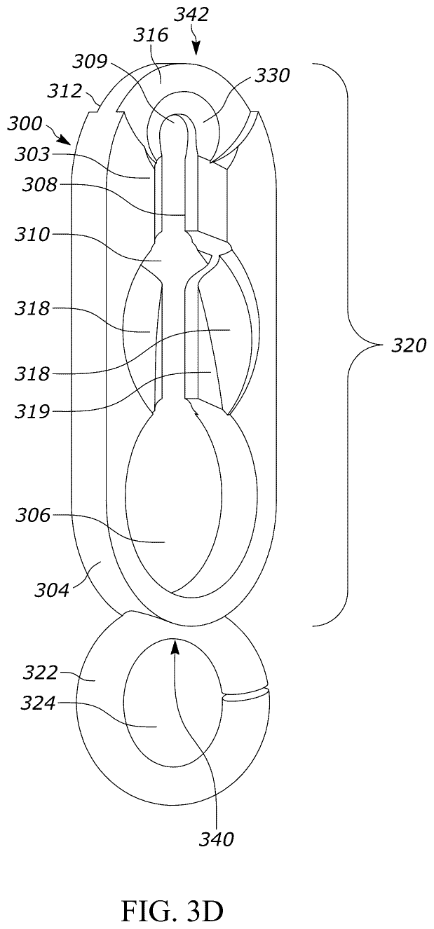

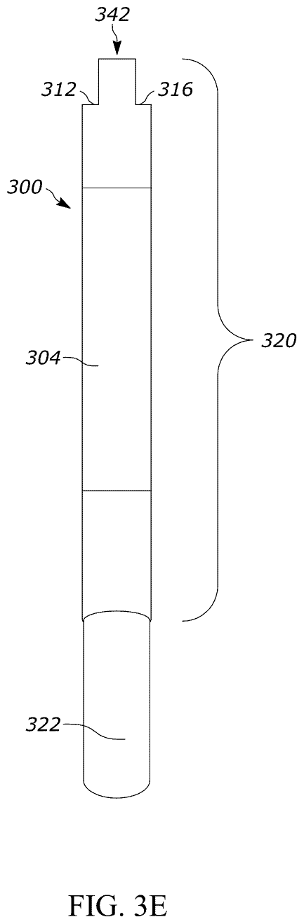

FIGS. 3A-3E illustrate an exemplary embodiment of a bail 300 that can couple with chains that include a plurality of links, a plurality of balls (e.g., spheres), or a combination of links and balls. More specifically, the bail 300 is defined by a body 320 having a first end 340 and a second end 342. The body 320 is further defined by a first surface 302 and a second surface 303 that are spaced by a continuous sidewall 304. The second surface 303 can be a mirror image of the first surface 302, including the openings and recessed areas discussed below. The bail 300 can be made of any rigid or flexible material known in the art. For example, the bail 300 can be made of metal including gold, silver, aluminum, steel, brass, copper, nickel, and other metals known in the art. Alternatively, the bail 300 can be made of polymer materials including plastics and rubbers.

A primary opening 306 is disposed at the first end 340 of the body 320. The primary opening 306 extends through the body 320 from the first surface 302 to the second surface 303. A secondary opening 308 extends from the primary opening 306 towards the continuous sidewall 304 in the direction of the second end 342 of the body 320, terminating at a secondary opening end 309, which does not interrupt the continuous sidewall 304. The secondary opening 308 can extend through the body 320 from the first surface 302 to the second surface 303.

A secondary opening surface 319 extends between the first surface 302 and the second surface 304 along the boundary of the secondary opening 308. The secondary opening surface 319 can be curved, planer, a combination of connected planar segments, or combination of planar and curved segments. For example, in FIGS. 3A-3E, the secondary opening surface 319 is a combination of curved and planar segments.

Between the primary opening 306 and the secondary opening end 309, a tertiary opening 310 extends from the secondary opening 308. In some embodiments, the tertiary opening 310 extends transversely from the secondary opening end 309. The tertiary opening 310 extends through the body 320 of the bail 300 from the first surface 302 to the second surface 303. The tertiary opening 310 can be many shapes, including but not limited to arcuate, concave, and polyhedral shapes. For example, in FIGS. 3A-3E, the tertiary opening 110 is concave.

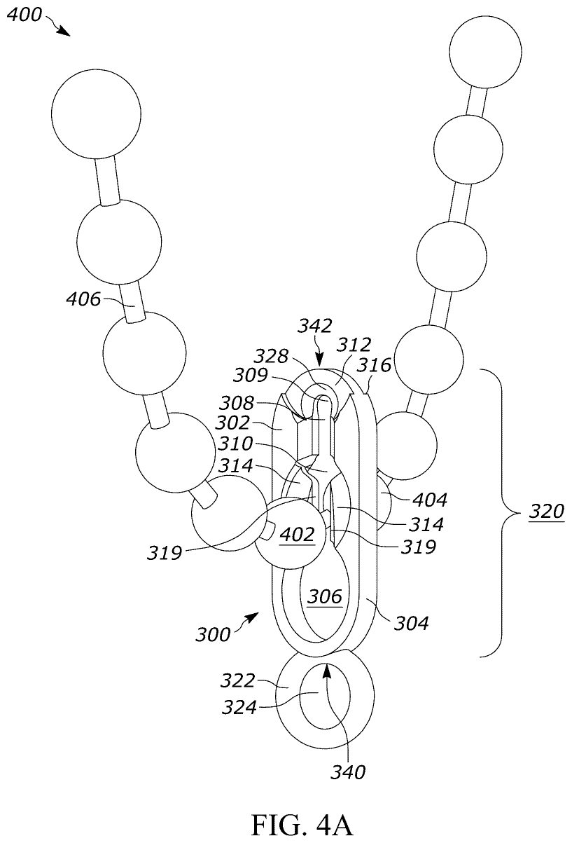

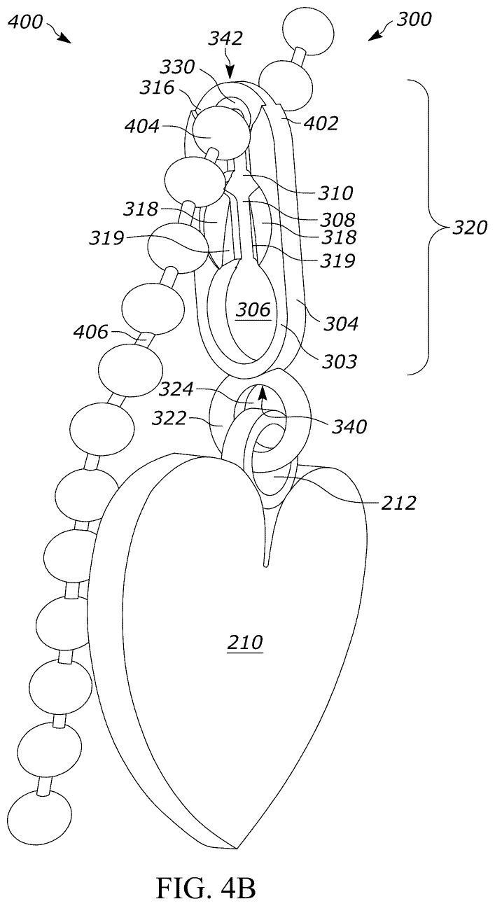

The bail 300 also includes a bail connection loop 322. The bail connection loop 322 may extend from the continuous sidewall 304 and may be positioned such that it extends from the continuous sidewall 304 at the first end 340 of the body 320. The bail connection loop 322 can be a closed shape such as a circle, square, or other any other shape known in the art. An ornamental component (e.g., a charm, a pendant, other decorative element) can be attached to the bail 300 via the primary opening 306 or the bail connection loop 322. (See FIG. 4B). It is understood that in some embodiments, the bail 300 does not include the bail connection loop 322, for example, similar to the bail 100 in FIGS. 1A-1E.

The bail 300 also includes a first recessed area 312 disposed around the secondary opening end 309. The first recessed area 312 may be parallel with the first surface 302, angled relative to the first surface 302, or concave. For example, in FIGS. 3A-3E, the first recessed area 312 is recessed into the first surface 302 of the bail 300 around the secondary opening end 309 at the second end 342 of the bail 300. The first recessed area 312 can extend from the secondary opening end 309 to the continuous sidewall 304, and may be many shapes, including but not limited to arcuate, concave, and polyhedral shapes.

A second recessed area 314 is disposed on the body 320 between the primary opening 306 and the tertiary opening 310. The second recessed area 314 is recessed into the first surface 302 of the bail 300 in an area between the primary opening 306 and the tertiary opening 310. The secondary opening 308 can bisect the second recessed area 314. The second recessed area 314 may be angled or form a concave shape such that a depth of the second recessed area 314 is greater at the end or ends disposed toward the tertiary opening 310 than the end or ends disposed toward the primary opening 306. The second recessed area 314 may be many shapes, including but not limited to arcuate, concave, and polyhedral shapes. For example, in FIGS. 3A-3E, the second recessed area 314 is concave.

As mentioned above, the second surface 303 can mirror the first surface 302 including the recessed areas. More specifically, a third recessed area 316 may be present opposite the first recessed area 312 on the second surface 303. The third recessed area 316 may mirror the first recessed area 312 or may vary in shape, angle, and depth from the first recessed area 312. A fourth recessed area 318 may be present opposite the second recessed area 314 on the second surface 303. The fourth recessed area 318 may mirror the second recessed area 314 or may vary in shape, angle, and depth.

A fifth recessed area 328 is disposed within the first recessed area 312 at the secondary opening end 309. The fifth recessed area 328 is recessed into the first surface 302 of the bail 300 within the first recessed area 312. The fifth recessed area 328 may be parallel with the first surface 302, angled relative to the first surface 302, or concave. Further, the fifth recessed area 328 can be shaped so that it can couple with a spherical element. The fifth recessed area 328 may extend from the secondary opening end 309 to the continuous sidewall 304 or may terminate before reaching the continuous sidewall 304. The fifth recessed area 328 can be many shapes, including but not limited to arcuate, concave, and polyhedral shapes.

A sixth recessed area 330 may be present opposite the fifth recessed area 328 on the second surface 303. The sixth recessed area 330 may mirror the fifth recessed area 328 or may vary in shape, angle, and depth.

As will now be discussed in more detail, the recessed areas allow for receiving and coupling with elements of a chain, thereby securing the bail to the chain. As illustrative examples, FIGS. 4A and 4B shows the bail 300 coupled to a chain 400 according to two exemplary embodiments. Notably, FIG. 4B includes a charm 210. However, it is understood that a charm 210 could be similarly included with the bail 300 in FIG. 4A. The chain 400 includes a plurality of elements. In the illustrative example shown in FIGS. 4A and 4B, the plurality of elements are ball shaped (e.g., spheres). Thus, the chain 400 can be referred to as a ball chain.

As shown in FIG. 4A, the bail 300 is shown coupled to a chain 400 to restrict movement of the bail 300 along the length of the chain 400. The primary opening 306 allows for the chain 400 to pass through the primary opening 306. The chain 400 includes a plurality of elements, including at least a first ball element 402 and a second ball element 404. The plurality of elements, including the first ball element 402 and the second ball element 404, are linked (e.g., interconnected) together by threading a wire 406 through each element. The first ball element 402 is adjacent to the second ball element 404 along the wire 406, and both the first ball element 402 and second ball element 404 can be spherical. In this embodiment, the wire 406 passes through the secondary opening 308 with the first ball element 402 positioned near the first surface 302 and the second ball element 404 positioned near the second surface 303. The wire passes through the secondary opening 308 until the first ball element 402 and the second ball element 404 simultaneously couple with a portion of the secondary opening surface 319. Once coupled, the bail 300 will be prevented from moving down the chain 400.

In the embodiment shown in FIG. 4B, the bail 300 is again configured to couple with a chain 400 to prevent the bail 300, and thereby the charm 210 connected to the bail 300, from shifting along the length of the chain 400. In this embodiment, the wire 406 passes through the secondary opening 308 with the first ball element 402 positioned near the first surface 302 and the second ball element 404 positioned near the second surface 303. The wire passes through the secondary opening 308 until the first ball element 402 couples with the fifth recessed area 328 and the second ball element 404 simultaneously couples with the sixth recessed area 330. In this embodiment, the first ball element 402 is a sphere and couples with the fifth recessed area 328 by engaging with the concave shape of the fifth recessed area 328. Similarly, the second ball element 404 is a sphere and couples with the sixth recessed area 330 by engaging with the concave shape of the sixth recessed area 330. Once coupled, the bail 300 and the charm 210 are prevented from moving down the chain 400.

It will be appreciated that various embodiments of the above-disclosed and other features and functions, or alternatives or varieties thereof, may be desirably combined into many other different embodiments. Various presently unforeseen or unanticipated alternatives, modifications, variations or improvements therein may be subsequently made by those skilled in the art which are also intended to be encompassed by the following claims.

1. A bail, comprising:
a body having a first surface and a second surface, wherein the first surface and the second surface are spaced by a continuous sidewall, and wherein the body has a first end and a second end opposite the first end;
a primary opening through the body from the first surface to the second surface;
a secondary opening extending from the primary opening towards the continuous sidewall to a secondary opening end, wherein the secondary opening forms a secondary opening surface disposed between the first surface and the second surface; and
a tertiary opening disposed between the primary opening and the secondary opening end.

2. The bail of claim 1, further comprising a first recessed area on the first surface at the secondary opening end.

3. The bail of claim 2, further comprising a second recessed area on the first surface disposed on the body between the primary opening and the tertiary opening.

4. The bail of claim 3, further comprising a third recessed area on the second surface, wherein the third recessed area mirrors the first recessed area.

5. The bail of claim 4, wherein:
the primary opening allows a chain to pass through the primary opening, wherein the chain includes a plurality of elements connected to each other, the plurality of elements including at least a first element connected to a second element; and
the chain contacts the secondary opening surface, wherein the third recessed area engages the first element and the second element engages the secondary opening end thereby securing the chain to the bail.

6. The bail of claim 5, wherein the plurality of elements includes a third element connected to the second element and the third element engages the second recessed area.

7. The bail of claim 1, wherein the tertiary opening extends transversely from the secondary opening.

8. A bail, comprising:
a body having a first surface and a second surface, wherein the first surface and the second surface are spaced by a continuous sidewall, and wherein the body has a first end and a second end opposite the first end;
a primary opening through the body from the first surface to the second surface;
a secondary opening extending from the primary opening towards the continuous sidewall to a secondary opening end, wherein the secondary opening forms a passage surface disposed between the first surface and the second surface;
a tertiary opening disposed between the primary opening and the secondary opening end;
a first recessed area at the secondary opening end; and
a second recessed area between the tertiary opening and the primary opening.

9. The bail of claim 8, wherein the second surface is a mirror image of the first surface, wherein the first recessed area is mirrored by a third recessed area and the second recessed area is mirrored by a fourth recessed area.

10. The bail of claim 8, wherein the tertiary opening extends transversely from the secondary opening.

11. The bail of claim 8, wherein the tertiary opening is a non-polyhedron with a concave curve.

12. The bail of claim 8, wherein the primary opening allows a chain to pass through, wherein the chain includes at least a first chain link connected to a second chain link and a third chain link connected to the second chain link.

13. The bail of claim 12, wherein the first chain link couples with the first recessed area while the third chain link simultaneously couples with the third recessed area thereby securing the bail to the chain.

14. A bail, comprising:
a body having a first surface and a second surface, wherein the first surface and the second surface are spaced by a continuous sidewall, and wherein the body has a first end and a second end opposite the first end;
a primary opening through the body from the first surface to the second surface;
a secondary opening extending from the primary opening towards the continuous sidewall to a secondary opening end, wherein the secondary opening forms a secondary opening surface disposed between the first surface and the second surface;
a tertiary opening disposed between the primary opening and the secondary opening end;
a first recessed area at the secondary opening end wherein a fifth recessed area is disposed within the first recessed area; and
a second recessed area between the tertiary opening and the primary opening.

15. The bail of claim 14, wherein the first recessed area is concave.

16. The bail of claim 14, further comprising a fourth recessed area opposite the second recessed area on the second surface, wherein the fourth recessed area is concave.

17. The bail of claim 14, further comprising a bail connection loop extending from the sidewall.

18. The bail of claim 14, wherein the secondary opening surface is curved.

19. The bail of claim 14, wherein a first ball element of a chain couples with the fifth recessed area and a second ball element of a chain couples with a sixth recessed area opposite the fifth recessed area on the second surface.

20. The bail of claim 19, wherein the first ball element and the second ball element are spherical.
